(19) United States
(12) Patent Application Publication
(10) Pub. No.: US 2015/0281802 A1
(43) Pub. Date: Oct. 1, 2015

(54) METHOD FOR PROCESSING MULTI-CHANNEL ALTERNATIVE ADVERTISEMENT THROUGH SINGLE SOURCE AND MANAGING SCHEDULE

(71) Applicant: DOUBLE U CORPORATION CO., LTD., Seoul (KR)

(72) Inventor: Jung-Jin Park, Seongnam-si (KR)

(21) Appl. No.: 14/438,007

(22) PCT Filed: Aug. 4, 2014
(86) PCT No.: PCT/KR2014/007153

§ 371 Date: Apr. 23, 2015

(30) Foreign Application Priority Data
Aug. 7, 2013 (KR) 10-2013-0093650

(51) Int. Cl. H04N 21/81; H04N 21/234

(52) U.S. Cl. CPC H04N 21/812; H04N 21/23424

(57) ABSTRACT

Disclosed is a media processing device for a multi-channel advertisement processing of a single media. An example media processing device may include a memory, a decoder configured to decode media data, a scheduler for generating a control command for the media data and a plurality of binding modules. Each of the plurality of binding modules may be configured to receive the decoded media data from the decoder. Each of the plurality of binding modules may be configured to receive the control command from the scheduler. Each of the plurality of binding modules may be configured to combine the decoded media data with a corresponding advertisement based on the control command.

### TECHNICAL FIELD

The embodiments described herein pertain generally to a method for processing a multi-channel alternative advertisement through a single source and managing a schedule.

### BACKGROUND

Unless otherwise indicated herein, the materials described in this section are not prior art to the claims in this application and are not admitted to be prior art by inclusion in this section.

Recently, with mobile device, Internet, communication, and broadcasting technologies having been developed, it has become possible to process various types of videos and provide the processed videos, for example, broadcasting videos, to various computing devices such as desktop computers, laptop computers, mobile devices, etc. By providing broadcasting videos as such, broadcasters can create profits. In an example that a broadcasting video source is received from a public TV network or a cable TV network and then processed to be suitable for various types of computing devices, an alternative advertisement can be combined with the video when the video is processed, and the video can be transmitted to various types of computing devices. Thus, advertising earnings can be obtained.

### DISCLOSURE OF THE INVENTION

### Problems to be Solved by the Invention

In an example that a video service provider receives a broadcasting video source from a public or a cable TV network to provide a processed video service, e.g., a streaming service, the video service provider can provide a video including the advertisement to consumers by processing the video source and scheduling an advertisement to be combined.

However, even if the same video is provided, an advertisement to be provided may be limited depending on various factors such as a time for providing the video, an area where the video is provided, a device for providing the video, and/or a type of the video. In an example, in some areas where a video is provided, certain advertisements may not be legally permitted. In another example, in some devices for providing a video, certain advertisements may be limited by several contractual reasons. Further, an advertisement to be provided by an advertisement provider to consumers may vary depending on various factors. In an example, the advertisement provider may prefer to provide consumers using a specific mobile device with an advertisement regarding an accessory usable in their mobile device.

Therefore, as described above, when a broadcasting video is transmitted in various environments, for example, to various types of devices, if alternative advertisements corresponding to the respective environments can be provided, commercializing various advertisements can be available and applications in various fields can be expected by targeting advertisement. However, if a system for each advertisement is equipped in order to combine the alternative advertisements corresponding to the respective environments, costs may increase. Therefore, it is necessary to not only transmit a video to multiple channels using a single video source but also provide an advertisement corresponding to each channel.

### Means for Solving the Problems

In an embodiment, a media processing device for a multi-channel advertisement processing of a single media is described. An example media processing device may include a memory, a decoder configured to decode media data, a scheduler for generating a control command for the media data and a plurality of binding modules. Each of the plurality of binding modules may be configured to receive the decoded media data from the decoder. Each of the plurality of binding modules may be configured to receive the control command from the scheduler. Each of the plurality of binding modules may be configured to combine the decoded media data with a corresponding advertisement based on the control command.

In further examples, the media processing device may further include a plurality of encoders coupled to the plurality of binding modules with one-to-one correspondence. In an example, the media data may include video data and audio data and the control command may include at least one control value for the video data and audio data. In another example, the control command may includes information regarding start time of advertisement to be combined with the media data in the media data. Each of the plurality of binding modules may be configured to transmit the media data combined with the corresponding advertisement to each of corresponding type of devices.

In further examples, each of the plurality of binding modules may be configured to be allocated a corresponding memory area of the memory. In another example, the scheduler is further configured to update the control command, and each of the plurality of binding modules may be configured to receive the updated control command.

In another embodiment, a media processing method for a multi-channel advertisement processing of a single media is described. An example media processing method may include decoding media data; generating control command for the media data; combining, in a first binding module including a first memory area, the decoded media data with a first advertisement based on the control command and combining, in a second binding module including a second memory area, the decoded media data with a second advertisement based on the control command; and encoding the media data combined with the first advertisement and the media data combined with the second advertisement, respectively

In still another embodiment, a computer-readable storage medium having computer executable instructions stored therein is described. Example computer executable instructions, when executed, may be configured to cause a computer to perform operations including receiving decoded media data; receiving control command; combining, in a first binding module including a first memory area, the decoded media data with a first advertisement based on the control command and combining, in a second binding module including a second memory area, the decoded media data with a second advertisement based on the control command; and encoding the media data combined with the first advertisement and the media data combined with the second advertisement.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is an overall schematic diagram showing an environment where a media processing system in accordance with at least some embodiments of the present disclosure is operated;

FIG. 2 is a schematic block diagram showing an exemplary media processing system in accordance with at least some embodiments of the present disclosure;

FIG. 3 illustrates an exemplary control command in accordance with at least some embodiments of the present disclosure;

FIG. 4 is a flowchart showing a process flow of a control command executed in a binding module, in accordance with at least some embodiments of the present disclosure;

FIG. 5 illustrates a computer program product, which may be used to media process in accordance with at least some embodiments of the present disclosure; and

FIG. 6 is a block diagram showing an example embodiment of a computing device arranged in accordance with at least some embodiments of the present disclosure.

### MODE FOR CARRYING OUT THE INVENTION

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

The present disclosure is generally drawn, inter alia, to a device, a system, a method, and a computer-readable storage medium regarding a process of a multi-channel advertisement for a single media.

In various example embodiments, a media processing system may be configured to receive a media data source from an external media source. The media processing system may be configured to capture media data based on the received media data source. The media processing system may be configured to decode the captured media data and generate a control command for the captured media data. The media processing system may include a plurality of binding modules, and each of the plurality of binding modules may store the decoded media data in a corresponding memory area and combine the decoded media data with its corresponding advertisement based on the control command. The media data combined with the corresponding advertisement may be transmitted to an encoder corresponding to each binding module.

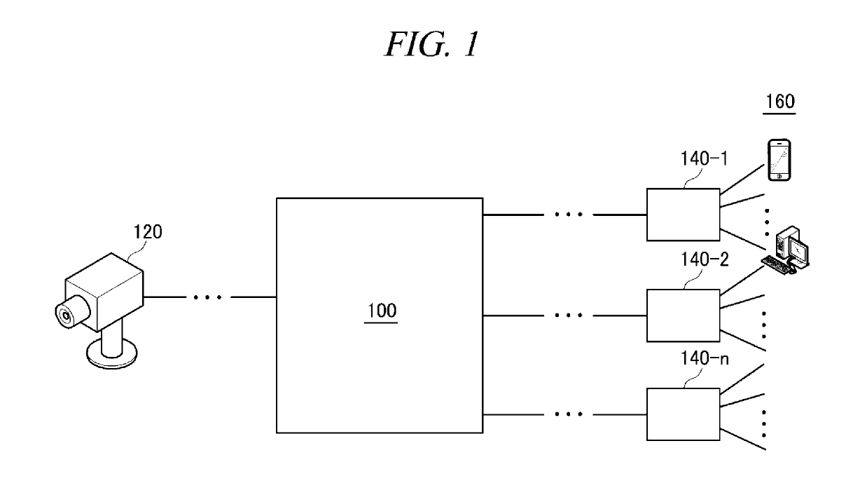

FIG. 1 is an overall schematic diagram showing an environment where a media processing system 100 in accordance with at least some embodiments of the present disclosure is operated. Media processing system 100 may receive a media data source from an external media source 120. As will be described in detail below, media processing system 100 may include a capture board, and the capture board may capture media data based on the received media data source.

In an embodiment, the media data may include video data and audio data. Such video data and audio data may include PTS (presentation time stamp) values, respectively. Further, the video data and the audio data may include a unit time value which forms the basis for scheduling. By way of example, the unit time value may be μs. Media processing system 100 may generate a control command for media data. In an example, such a control command may be used to schedule media data.

In an embodiment, media processing system 100 may include a decoder and may be configured to decode the captured media data to be suitable to be processed. As will be described in more detail below, media processing system 100 may include a plurality of binding modules. Each of the plurality of binding modules may receive the decoded media data and the generated control command. Each binding module may combine the decoded media data with a corresponding advertisement based on the control command. In further examples, the media data combined with the corresponding advertisement may be transmitted to an encoder corresponding to each binding module.

Each of the media data combined with the corresponding advertisement may be transmitted to a corresponding type of devices through a channel. In an example, each of the media data may be transmitted to their corresponding servers 140-1, 140-2 . . . 140-n through channels, respectively. Each of servers 140-1, 140-2 . . . 140-n may be configured to transmit the media data to a specific type of device 160. By way of example, server 140-1 may provide the media data to the specific type of devices 160 using a specific communication service, and server 140-2 may transmit the media data to the same or different type of devices using the same or different communication service as compared with server 140-1. However, it should be understood that media processing system 100 in accordance with the present disclosure may not be limited to transmit media data via servers 140-1, 140-2 . . . 140-n respectively corresponding to channels, but may transmit media data directly to corresponding devices through respective channels without using servers 140-1, 140-2 . . . 140-n. As described above, since each binding module combines media data with a corresponding advertisement to provide them, commercializing various types of advertisements can be available. Further, since equipments for the system can be simplified, and the media processing system can provide a multi-channel media data combined with the corresponding advertisements using the single media data source, it is possible to reduce costs.

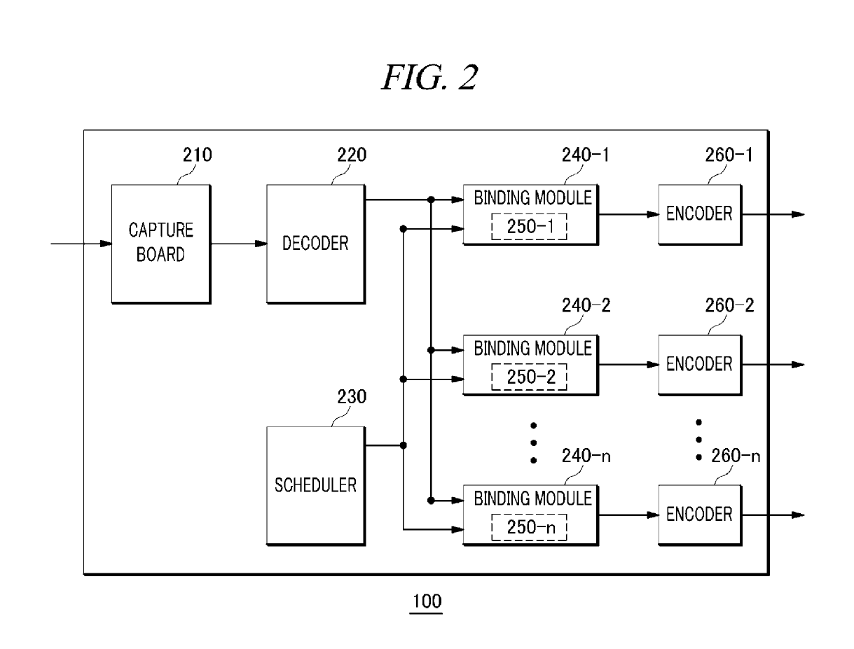

FIG. 2 is a schematic block diagram showing the exemplary media processing system 100 in accordance with at least some embodiments of the present disclosure. The exemplary media processing system 100 may include a capture board 210, a decoder 220, a scheduler 230, and a plurality of binding modules 240-1, 240-2 . . . 240-n. In further examples, the media processing system 100 may include a plurality of encoders 260-1, 260-2 . . . 260-n.

Capture board 210 may be configured to receive a media data source from a media source and capture media data using the received media data source. In an example, a media data source received from a media source such as external media source 120 may be in the form of an analog signal, and in such example, capture board 210 may capture media data by digitizing the received media data source to obtain the media data. However, it will be understood by those skilled in the art that the media data source is not limited to the form of an analog signal and may be in the form of a digital signal, and, thus, such a digital signal may be received without using the capture board. Capture board 210 may capture the media data and transmit the captured media data to decoder 220.

Decoder 220 may decode the media data. The media data may include video data and audio data. In an example, the video data and the audio data may include PTS (presentation time stamp) values, respectively. Further, the video data and the audio data may include a unit time value which forms the basis for scheduling. By way of example, the unit time value may be μs. Decoder 220 may transmit the decoded media data to each of the plurality of binding modules 240-1, 240-2 . . . 240-n. As will be described in detail below, the decoded media data may be transmitted to be stored in memory areas 250-1, 250-2 . . . 250-n each of which is allocated to the plurality of binding modules 240-1, 240-2 . . . 240-n.

Scheduler 230 may generate a control command for the media data. In an embodiment, the control command may be involved in scheduling that is related to combinations of media data and advertisements. In an example, the control command may define a start time of an advertisement to be combined with the media data. In further examples, the control command may include at least one control value.

The plurality of binding modules 240-1, 240-2 . . . 240-n may be configured to be allocated the corresponding memory areas 250-1, 250-2 . . . 250-n, respectively. Each of memory areas 250-1, 250-2 . . . 250-n may include at least a partial area of a memory, and may be, for example, an area of the memory divided by the request of media processing system 100 or each binding module. According to requirements in some implementations, each of memory areas 250-1, 250-2 . . . 250-n may be a virtually-allocated memory area.

In an example, first memory area 250-1 may be allocated to the binding module 240-1. In this example, binding module 240-1 may receive the decoded media data from decoder 220 and store the received media data in first memory area 250-1. Similarly, second memory area 250-2 to n^{th} memory area 250-n may be allocated to binding module 240-2 to binding module 240-n, respectively, and binding module 240-2 to binding module 240-n may receive the decoded media data from decoder 220 and store the received media data in second memory area 250-2 to the n^{th} memory area 250-n, respectively.

Each of the plurality of binding modules 240-1, 240-2 . . . 240-n may be configured to receive the generated control command from scheduler 230. In an embodiment, each of the plurality of binding modules 240-1, 240-2 . . . 240-n may be configured to combine the decoded media data with a corresponding advertisement based on the received control command. By way of example, first binding module 240-1 may be configured to receive a control command from scheduler 230 and, based on the received control command, combine the decoded media data stored in first memory area 250-1 with a first advertisement. In an example, first binding module 240-1 may analyze the received control command to obtain a start time of the first advertisement to be combined and at least one control value. First binding module 240-1 may combine the decoded media data with the first advertisement based on the obtained values. In further embodiments, the decoded media data may be combined with other advertisements in addition to the first advertisement based on the values obtained from the control command.

In further examples, scheduler 230 may be configured to update the control command, and each of the plurality of binding modules 240-1, 240-2 . . . 240-n may be configured to receive the updated control command and obtain an updated start time of the first advertisement and at least one updated control value. By way of example, if media data are transmitted in a streaming manner, first binding module 240-1 may be configured to transmit the media data combined with the first advertisement and then combine the media data with another advertisement in addition to the first advertisement based on the control command to continuously transmit the media data.

In further embodiments, media processing system 100 may further include plurality of encoders 260-1, 260-2 . . . 260-n coupled to respective binding modules 240-1, 240-2 . . . 240-n with one-to-one correspondence. The plurality of encoders 260-1, 260-2 . . . 260-n may receive media data combined with corresponding advertisements and transmitted from the respective binding modules 240-1, 240-2 . . . 240-n, and encode the received media data.

The media data combined with corresponding advertisements may be transmitted to devices corresponding to the respective binding modules 240-1, 240-2 . . . 240-n.

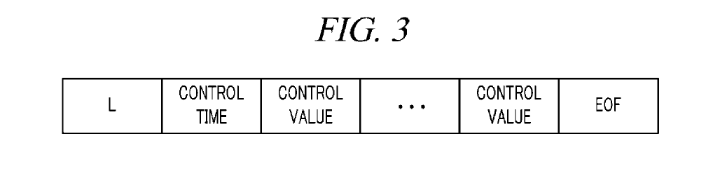

FIG. 3 illustrates an exemplary control command in accordance with at least some embodiments of the present disclosure. Such a control command may be generated by a scheduler such as scheduler 230 of media processing system 100 depicted in FIG. 2. The control command may be formed of a series of codes, and may include control time and at least one control value (control value 1, . . . , control value n) as depicted in FIG. 3. In an example, the control command may include an EOF (End of File) code indicating the end of the command.

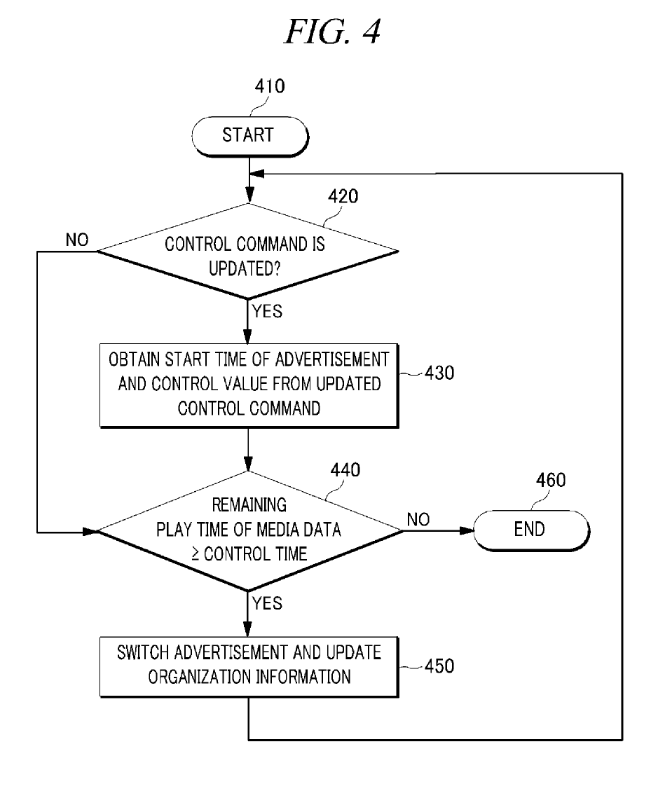

FIG. 4 is a flowchart showing a process flow of a control command executed in a binding module, in accordance with at least some embodiments of the present disclosure. The process of a control command depicted in FIG. 4 may include one or more operations, functions, or actions as illustrated by blocks 420, 430, 440, 450 and/or 460. The various blocks are not intended to limit the described embodiment. By way of example, those skilled in the art may appreciate that as for the present process disclosed herein, the functions performed in the process and method may be implemented in a different order. Further, the outlined operations are only provided as examples, and some of the operations may be optional, combined into fewer operations, or expanded into additional operations without departing from the spirit of the disclosed embodiment.

In block 420, a binding module may determine whether a control command is updated. A scheduler such as scheduler 230 may update the control command, and the binding module such as binding modules 240-1, 240-2 . . . 240-n may receive the updated control command. The binding module, in combining decoded media data with a corresponding advertisement, may determine whether the received control command is the updated control command different from the previous control command. If it is determined that the control command received from the scheduler is the updated control command, the process may be followed by block 430.

In block 430, the binding module may obtain a start time of an advertisement and at least one control value from the updated control command. In an example, the binding module can obtain a control time value from the updated control command.

If it is determined that the control command is not the updated control command in block 420 or if the start time of an advertisement and the control value are obtained from the updated control command in block 430, the process may be followed by block 440. In block 440, the binding module may determine whether remaining play time of the media data is equal to or more than the control time value. If the remaining play time of the media data is equal to or more than the control time value, the process may be followed by block 450.

In block 450, the binding module may switch an advertisement to be combined with the media data based on the control command, and may renew organization information. In an example, the organization information may be stored in a corresponding memory area allocated to the binding module. In another example, it may be stored in a memory of a media processing system such as media processing system 100 and managed in an integrated manner. The organization information may include, for example, advertisement organization information.

If the remaining play time of the media data is less than the control time value in block 440, the process may be followed by block 460, and the process of the control command may be ended.

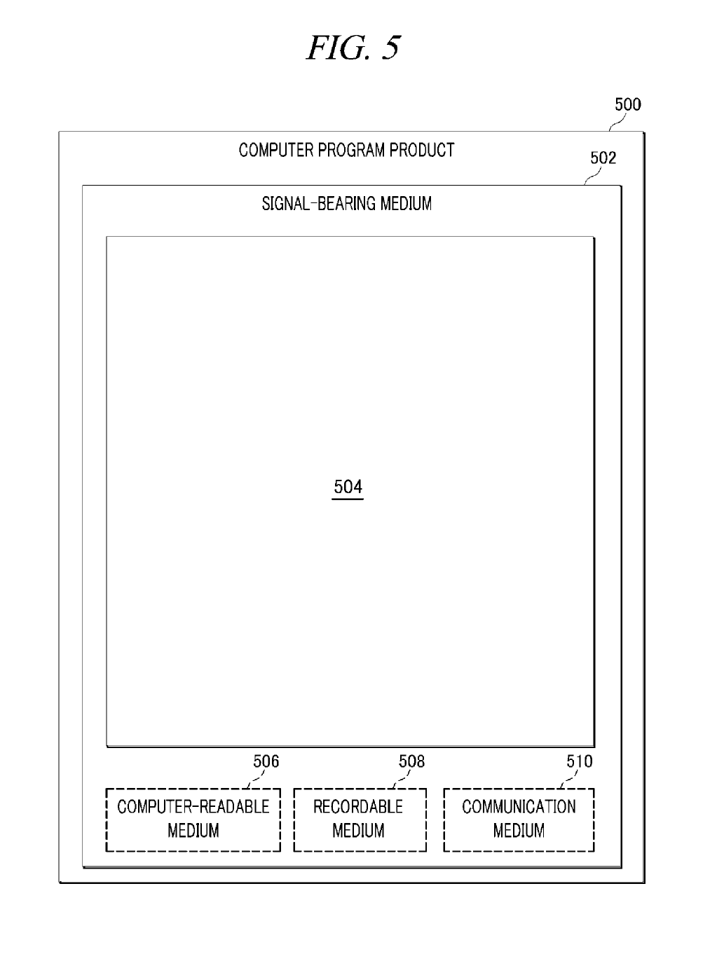

FIG. 5 is a schematic diagram showing a computer program product 500 including a computer program for implementing a computer device in a computing device, arranged in accordance with at least some example embodiments disclosed herein. In an example embodiment, an exemplary computer program product may be provided using a signal-including medium 502. In some embodiments, signal bearing medium 502 of at least one computer program product 500 may include a computer-readable medium 506, a recordable medium 508, and/or a communication medium 510.

Instructions 504 may include at least one of one or more instructions for receiving decoded media data, one or more instructions for receiving a control command, one or more instructions for combining, in a first binding module including a first memory area, the decoded media data with a first advertisement based on the control command and combining, in a second binding module including a second memory area, the decoded media data with a second advertisement based on the control command, or one or more instructions for encoding the media data combined with the first advertisement and encoding the media data combined with the second advertisement.

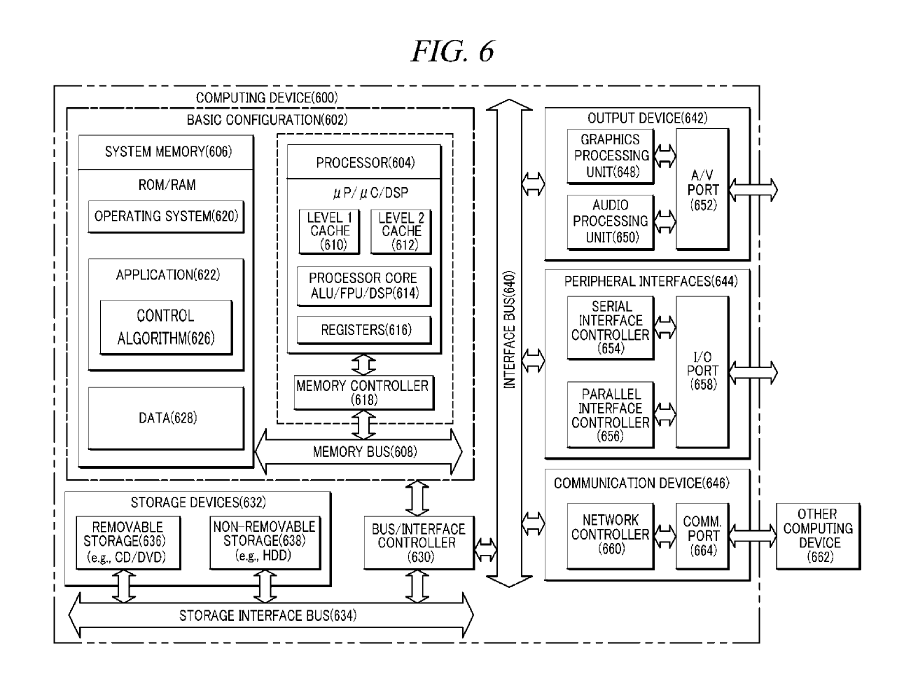

FIG. 6 is a block diagram showing an example computing device 600 arranged in accordance with at least some example embodiments of the present disclosure. In an exemplary basic configuration 602, computing device 600 may include one or more processor 604 and system memory 606. A memory bus 608 may be used for communicating between a processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include control algorithm 626 arranged to perform functions described herein including function blocks and/or actions described regarding a process for media processing system 100 and/or binding modules 240-1, 240-2, . . . , 240-n illustrated in FIG. 2 and/or a process illustrated in FIG. 4. Program Data 624 may include data 628, for example, data corresponding to a static network environment, to be used with control algorithm 626. In some embodiments, application 622 may be arranged to be operated with the program data 624 on operating system 620 such that implementation for determining an optimum transmission environment can be provided as described herein. By way of example, binding modules 240-1, 240-2 . . . 240-n may include the computing device 600 in whole or in part, and enable all or part of application 622 to be performed such that implementation for determining an optimum transmission environment can be provided as described herein. This described basic configuration is illustrated in FIG. 6 by those components within dashed line 602.

Computing device 600 may have additional features or functionality, and additional interfaces to facilitate communications between the basic configuration 602 and any required devices and interfaces. For example, a bus/interface controller 630 may be used to facilitate communications between the basic configuration 602 and one or more data storage devices 632 via a storage interface bus 634. The data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage 636 and non-removable storage 638 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of device 600.

Computing device 600 may also include an interface bus 640 for facilitating communication from various interface devices (e.g., output interfaces, peripheral interfaces, and communication interfaces) to the basic configuration 602 via the bus interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication via one or more communication ports 664. The communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations or implemented in a workstation or a server configuration.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described in the present disclosure can be effected (e.g., hardware, software, and/or firmware), and a favorable vehicle may vary with the context in which the processes and/or systems and/or other technologies are deployed. By way of example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various example embodiments of the devices and/or processes through the block diagrams, flowchart, and/or examples. Insofar as such block diagrams, flowchart, and/or examples contain one or more functions and/or operations, it will be understood by those skilled in the art that each function and/or operation within such block diagrams, flowchart, or examples can be implemented, individually and/or collectively, by a wide range of hardware, software, firmware, or virtually any combination thereof. In an example embodiment, several portions of the subject matter described in the present disclosure may be implemented via an ASIC (Application Specific Integrated Circuit), FPGA (Field Programmable Gate Array), DSP (Digital Signal Processor), or other integrated formats. However, those skilled in the art will recognize that some aspects of the example embodiments described in the present disclosure, in whole or in part, can be equivalently implemented in integrated circuits, as one or more computer programs executed on one or more computers (e.g., as one or more programs executed on one or more computer systems), as one or more programs executed on one or more processors (e.g., as one or more programs executed on one or more microprocessors), as firmware, or as virtually any combination thereof, and that designing the circuitry and/or writing the code for the software and or firmware would be within the skill of those skilled in the art in light of the present disclosure. In addition, those skilled in the art will appreciate that the mechanisms of the subject matter of the present disclosure are capable of being distributed as a program product in various forms, and that an example embodiment of the subject matter of the present disclosure applies regardless of the particular type of signal-bearing medium used to actually carry out the distribution. Examples of a signal-bearing medium include, but are not limited to, a recordable type medium such as a flexible disk, a hard disk drive (HDD), a CD, a DVD, a digital tape, a computer memory, etc. and a transmission type medium such as a digital and/or analog communication medium (e.g., a fiber optic cable, a waveguide, a wired communications link, a wireless communication link, etc.).

While certain exemplary techniques have been described and shown herein using various methods and systems, it should be understood by those skilled in the art that various other modifications may be made, and equivalents may be substituted, without departing from the claimed subject matter. Additionally, many modifications may be made to adapt a particular situation to the teachings of the claimed subject matter without departing from the central concept described herein. Therefore, it is intended that claimed subject matter not be limited to the particular examples disclosed, but that such claimed subject matter may also include all implementations falling within the scope of the appended claims and equivalents thereof.

We claim:

1. A media processing device for a multi-channel advertisement processing of a single media, the media processing device comprising:
a memory;
a decoder configured to decode media data;
a scheduler for generating a control command for the media data; and
a plurality of binding modules,
wherein each of the plurality of binding modules is configured to receive the decoded media data from the decoder,
each of the plurality of binding modules is configured to receive the control command from the scheduler, and
each of the plurality of binding modules is configured to combine the decoded media data with a corresponding advertisement based on the control command.

2. The media processing device of claim 1, further comprising:
a plurality of encoders coupled to the plurality of binding modules with one-to-one correspondence.

3. The media processing device of claim 1,
wherein the media data includes video data and audio data, and
the control command includes at least one control value for the video data and audio data.

4. The media processing device of claim 1,
wherein the control command includes information regarding start time of advertisement to be combined with the media data in the media data.

5. The media processing device of claim 1,
wherein each of the plurality of binding modules is configured to transmit the media data combined with the corresponding advertisement to each of corresponding type of devices.

6. The media processing device of claim 5,
wherein each of the plurality of binding modules is configured to transmit the media data combined with the corresponding advertisement to each of corresponding type of devices in a streaming manner.

7. The media processing device of claim 1,
wherein each of the plurality of binding modules is configured to be allocated a corresponding memory area of the memory.

8. The media processing device of claim 1,
wherein the scheduler is further configured to update the control command, and
wherein the plurality of binding modules is further configured to receive the updated control command.

9. A media processing method for a multi-channel advertisement processing of a single media, the media processing method comprising:
decoding media data;
generating a control command for the media data;
combining, in a first binding module including a first memory area, the decoded media data with a first advertisement based on the control command and combining, in a second binding module including a second memory area, the decoded media data with a second advertisement based on the control command; and
encoding the media data combined with the first advertisement and the media data combined with the second advertisement, respectively.

10. The media processing method of claim 9,
wherein the encoding includes encoding, in a first encoder, the media data combined with the first advertisement and encoding, in a second encoder, the media data combined with the second advertisement.

11. The media processing method of claim 9,
wherein the first advertisement is associated with a first type of a device and the second advertisement is associated with a second type of a device.

12. The media processing method of claim 9, further comprising:
transmitting the encoded media data in a streaming manner.

13. A computer-readable storage medium having computer executable instructions stored therein that, when executed, is configured to cause a computer to perform operations comprising:
receiving decoded media data;
receiving a control command;
combining, in a first binding module including a first memory area, the decoded media data with a first advertisement based on the control command and combining, in a second binding module including a second memory area, the decoded media data with a second advertisement based on the control command; and
encoding the media data combined with the first advertisement and the media data combined with the second advertisement.
